(19) United States
(12) Patent Application Publication
(10) Pub. No.: US 2006/0097070 A1
(43) Pub. Date: May 11, 2006

(54) External mix air assisted spray nozzle assembly

(75) Inventor: David C Huffman, Merrimack, NH (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: Spraying Systems Co., Wheaton, IL (US)

(21) Appl. No.: 10/530,991

(22) PCT Filed: Oct. 14, 2003
(86) PCT No.: PCT/US03/32462

§ 371 Date: Oct. 5, 2005

Related U.S. Application Data
(60) Provisional application No. 60/418,902, filed on Oct. 15, 2002.

(51) Int. Cl. B05B 1/28

(52) U.S. Cl. 239/290; 239/291; 239/294; 239/296

(57) ABSTRACT

A spray device comprising a body having a liquid discharge passage and a spray nozzle assembly affixed to the body is provided. The spray nozzle assembly includes a liquid spray tip for directing liquid from the liquid passage in the body into a predetermined spray pattern and an atomizing fluid cap. The liquid spray tip includes a forwardly extending nose portion that defines a liquid discharge orifice. The nose extends through a central opening in the air cap thereby defining an annular atomizing fluid discharge orifice that communicates with an atomizing fluid inlet. The nose extends in a downstream direction past the central opening in the air cap such that the liquid discharge orifice is arranged at least approximately 2 mm. downstream of the annular atomizing fluid discharge orifice.

### FIELD OF THE INVENTON

The present invention relates generally to spray nozzle assemblies, and more particularly, to external mix air atomizing spray nozzle assemblies in which a discharging liquid flow stream is atomized and formed into the desired spray pattern by pressurized air externally of the liquid discharge orifice.

### BACKGROUND OF THE INVENTION

External mix air atomizing spray nozzles are known for their ability to control liquid particle size and spray distribution by pressurized air, independent of liquid flow rate. They also can be used with relatively low pressure air supplies which can be generated by inexpensive blowers, rather than air compressors. Because atomization occurs externally of the liquid discharge orifice, the intermixing liquid and air streams can be susceptible to control and performance problems.

Conventional external mix spray nozzle assemblies, such as depicted in FIGS. 1 and 2, commonly comprise a nozzle body or spray tip 25a having a forwardly extending nose 31a that defines a liquid discharge orifice 32a and an air cap 26a mounted in surrounding relation to the nozzle body 25a. The air cap 26a has a central opening 33a within which the nozzle body nose 31a is positioned for defining a central annular atomizing air passage 34a about the nose 31a for discharging pressurized air in surrounding relation to the liquid flow stream for preliminarily atomizing and axially directing the discharging liquid stream. The air cap 26a further has a pair of integrally formed, diametrically opposed ears 50 which define fan air discharge orifices 39a for directing pressurized air streams at an angle, such as 45°, to the discharging liquid for further breaking down the liquid and directing the liquid particles into the desired spray pattern.

In the conventional air cap 26a the ears 50 from which the angled air jets are directed protrude from a front face of the air cap and extend axially downstream of the liquid discharge orifice 32a. While this form of air cap performs well with many materials, in spraying materials that are prone to build up, the protruding ears can be problem prone. Liquid forcefully atomized downstream of the liquid discharge orifice can cause random spray to collect on the ears and on the face of the air cap, resulting in a build up that eventually interferes with performance of the nozzle.

In the conventional external mix spray nozzle assembly, the liquid discharge orifice defining nose 31a also generally is flush with the central air cap end portion through which the central opening 33a extends, not extending outwardly more than one millimeter beyond the central air cap opening 33. This arrangement can further cause build up of solid material onto the exposed surfaces of the air cap. Indeed, liquid particles drawn radially outwardly by a low pressure area created by the atomizing air discharging from the central annular air passages about the nose can cause overspray to be deposited onto the face of the air cap surrounding the central annular air passage. This build up also can eventually interfere with the spray nozzle performance, and in some cases, block the atomizing air completely.

### OBJECTS AND SUMMARY OF THE INVENTION

It is an object of the present invention to provide an external mix air atomizing spray nozzle assembly which is adapted for more efficient and reliable operation.

Another object is to provide an external mix air atomizing spray nozzle assembly as characterized above which is operable with less likelihood of spray material build up on the face of the air cap or in and around the pressurized air discharge orifices.

A further object is to provide a spray nozzle assembly of the above kind that is relatively simple in design and lends itself to economical manufacture.

Other objects and advantages of the invention will become apparent upon reading the following detailed description and upon reference to the drawings, in which:

### BRIEF DESCRIPTION OF THE DRAWINGS

FIG. 1 is a longitudinal section of an external mix air atomizing spray nozzle assembly typical of the prior art;

FIG. 2 is an enlarged fragmentary section of the spray tip and air cap, showing the central liquid and pressurized air discharge orifices of the prior art nozzle assembly shown in FIG. 1;

FIG. 3 is a longitudinal section of an illustrative spray device having an spray nozzle assembly in accordance with the present invention;

FIG. 4 is a downstream end view of the spray nozzle assembly of the spray device shown in FIG. 3;

FIGS. 5 and 6 are fragmentary sections of the illustrated spray nozzle assembly, taken in the planes of line 5-5 and 66, respectively, in FIG. 4; and

FIG. 7 is an enlarged fragmentary section of the central end portion of the spray nozzle assembly as depicted in FIG. 6, again taken in the plane of line 6-6 in FIG. 4.

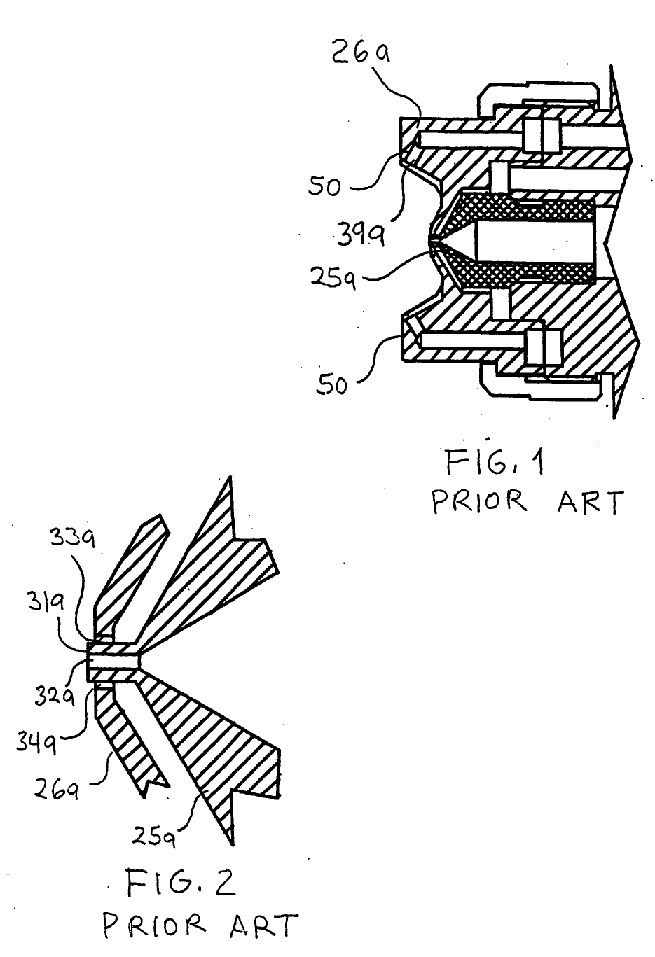

While the invention is susceptible of various modifications and alternative constructions, a certain illustrative embodiment thereof has been shown in the drawings and will be described below in detail. It should be understood, however, that there is no intention to limit the invention to the specific form disclosed, but on the contrary, the intention is to cover all modifications, alternative constructions, and equivalents falling within the spirit and scope of the invention.

### DESCRIPTION OF THE PREFERRED EMBODIMENT

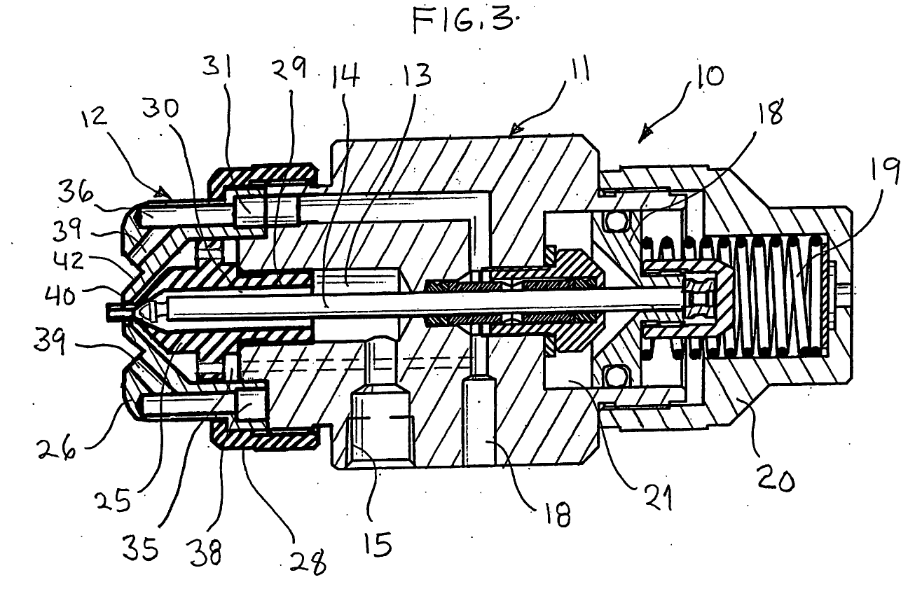

Referring now more particularly to FIG. 3 of the drawings, there is shown an illustrative air atomizing liquid spray device 10 comprising a spray gun body 11 having an external mix air assisted spray nozzle assembly 12 in accordance with the invention at a downstream end. The spray device 10 in this instance has a reciprocatable valve needle 13 for controlling discharging liquid spray for the nozzle assembly 12. The basic structure and mode of operation of the spray device are known in the art, for example, as shown in the aforementioned U.S. Pat. No. 5,707,010 and U.S. application Ser. No. 09/892,138, the disclosures of which are incorporated herein by reference. The overall structure and mode of operation of the spray device should be understood to be illustrative of only one example of a spray device with which the nozzle assembly of the present invention may be used.

The illustrated spray gun body 11 axially supports the valve shut-off needle 14 within an axial liquid flow passage 13 and has a liquid inlet port 15 for connection to the supply liquid to be sprayed and a pressurized air inlet port 18 for connection toga pressurized air source or other pressurized fluid for assisting in atomization of the liquid to be sprayed and for effecting controlled axial movement of the valve needle 14 between on and off positions.

For operating the valve needle 14, a rear end of the body 11 carries a drive piston assembly 18 and a compression spring 19 which is confined between an outer side of the piston assembly 18 and an internal end wall of a cap 20 screwed on to the rear of the body 11. The compression spring 19 biases the piston assembly 18, and hence the valve needle 14 affixed thereto forwardly to a fully seated, i.e. valve “closed” position as depicted in FIG. 3. The valve needle 14 is moved axially in the opposite direction (to the right as viewed in FIG. 3) against the force of spring 19 by control drive air or other fluid supplied to the inlet port 1 and through one or more connecting ports into a cylinder chamber 21 adjacent a forward side of the moveable piston assembly 18. The supply of control fluid, e.g. compressed air, is controlled externally, such as by solenoid actuated valves, for controlled opening of the valve needle 14 to allow liquid to be discharged through the spray nozzle assembly 12. It will be appreciated from the foregoing that the valve needle 14 may be selectively operated between on and off positions, including operation in a high speed cyclic on-off mode, e.g. as rapid as 180 on-off cycles per minute.

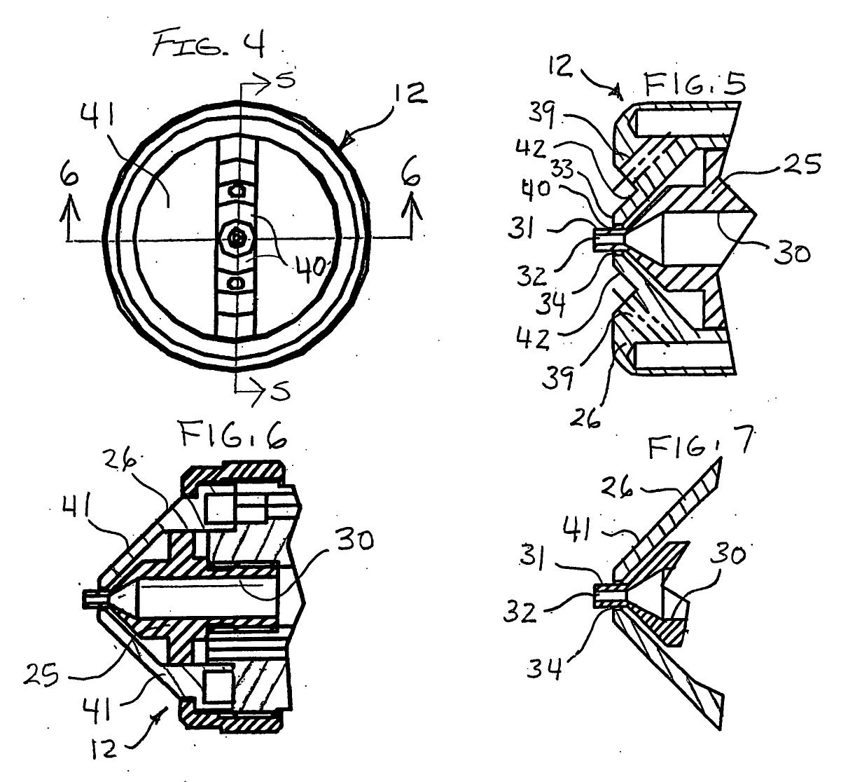

The spray nozzle assembly 12, as depicted in FIGS. 3-7, comprises a nozzle body 25 in the form of a liquid spray tip and an air cap 26 mounted in surrounding relation to the discharge end of the nozzle body 25 by a retaining ring 28. The nozzle body 25 is affixed to the forward end of the spray gun body 11 by a threaded stem 29 and has a central axial liquid passageway 30 communicating with the housing liquid passageway 13. The nozzle body 25 in this case has a forwardly extending nose portion 31 which defines a liquid discharge orifice 32 and which extends axially into a central opening 33 of the air cap 26, as depicted in FIGS. 5 and 7. The nose portion 31 is slightly smaller in diameter than the central air cap opening 33 for defining an annular atomizing air discharge orifice 34 communicating with the pressurized air inlet port 18 through an annular chamber 35 for discharging atomizing air parallel to liquid discharging from the liquid discharge orifice 32. The air cap 26 further is formed with a pair of opposed fan air passages 39 communicating with an annular manifold or air chamber 38, which in turn communicates with the pressurized air inlet port 18 for atomizing, forming, and directing the discharging liquid into the desired spray pattern. The fan air passages 39 in this case are oriented at an angle of about 45° to the longitudinal axis of the spray nozzle assembly. While in the illustrated spray device a single air source may be used for both atomizing air and fan air, it will be appreciated that separate air sources may be utilized for greater control.

In accordance with an important aspect of the invention, the liquid discharge orifice defining nose of the spray tip or nozzle body extends outwardly beyond the central end face of the air cap a distance of at least 2 mm. such that the annular atomizing air discharge orifice 34 is sufficiently upstream of a liquid discharge orifice 32 to be more effectively protected from the build up of solid material in liquid being atomized downstream of the liquid discharge orifice. In the illustrated embodiment, the central air cap portion through which the central opening 33 extends is defined by a substantially rectangular end face section 40 located between opposite rearwardly slanted side surfaces 41 of the air cap 26. The spray tip nose 31 extends at least 2 mm. beyond the central end face section 40, and preferably, a distance of 1 mm. plus the diameter of the liquid discharge orifice. Hence, if the liquid discharge orifice is 1 mm. the spray tip nose 31 preferably extends a distance of at least 2 mm. beyond the central air cap end face 40 and if the liquid discharge orifice is 2 mm. the nose 31 preferably extends a distance of at least 3 mm. beyond the central air cap end face 40. Such arrangement results in the liquid discharge orifice 32 being located sufficiently downstream the annular air atomizing discharge orifice 34 for minimizing the undesirable build up of solid materials about the annular air atomizing discharge orifice which might otherwise adversely affect the spray performance. At the same time, it has been further found that a low pressure condition resulting from the flow of pressurized atomizing air through the annular orifice 34 effectively draws the discharging liquid radially outwardly for interaction with and atomization by the discharging annular atomizing air stream.

In further carrying out the invention, the discharge orifices of the angled fan air passages 39 also are located in recessed, upstream relation to the liquid discharge orifice such that liquid drawn radially outwardly by the low pressure area about the atomizing air discharge orifice and broken up by the atomizing air again does not substantially impact the end face of the air cap or cause undesirable build up of solid materials about either the atomizing and fan air discharge orifices 34, 39. In the illustrated embodiment, the end face 44 of the air cap defined between the tapered side surfaces 41 extends in substantial co-planar relation vertically across the end of the air cap, as viewed in FIG. 4. The end face 40 is formed with a pair of V-shaped cut-outs 42 on opposite sides of the central air cap opening 33, with each V-shaped cut-out 42 having an outer surface oriented 45° to the longitudinal axis through which a respective angled fan passage 39 communicates. The other side of each V-shaped cut-out 42 defines an angled ramp surface which facilitates direction of the fan air radially inwardly toward the liquid discharging from the liquid discharge orifice 32. With the fan air discharge orifices 39 being formed through the angled sides of the V-shaped cuts 42, they are located both rearwardly of the liquid discharge orifice 32 as well as the atomizing air orifice 34 so as to be substantially protected from exposure to randomly directed liquid particles. With the fan air discharge orifices 39 recessed in such manner, it also can be seen that the air cap need not have forwardly projecting ears typical of the prior art.

From the foregoing, it can be seen that while the illustrated spray nozzle assembly atomizes and forms the liquid spray pattern away from the end face of the air cap, the likelihood of sprayed material building up on the face of the air cap and around the air atomizing and fan air discharge orifices is substantially reduced. This is accomplished by a spray nozzle assembly which has an earless air cap design and a spray tip with an extended liquid discharge orifice defining nose.

What is claimed is:

1. A spray device comprising:
a body having a liquid discharge passage;
a spray nozzle assembly affixed to the body, the spray nozzle assembly including a liquid spray tip for directing liquid from the liquid passage in the body into a predetermined spray pattern and an atomizing fluid cap, the liquid spray tip including a forwardly extending nose portion that defines a liquid discharge orifice, the nose extending through a central opening in the air cap thereby defining an annular atomizing fluid discharge orifice that communicates with an atomizing fluid inlet, the nose extending in a downstream direction past the central opening in the air cap such that the liquid discharge orifice is arranged at least approximately 2 mm. downstream of the annular atomizing fluid discharge orifice.

2. The spray device according to claim 1 wherein the atomizing fluid cap includes a pair of opposed angled fan atomizing fluid passages each having a respective fan discharge orifice that is located upstream of the annular atomizing fluid discharge orifice and the liquid discharge orifice.

3. The spray device according to claim 2 wherein the atomizing fluid cap includes an end face having a pair of V-shaped cutouts therein on opposite sides of the atomizing fluid discharge orifice, each fan discharge orifice being arranged in an angled side of a respective one of the V-shaped cutouts so as to direct atomizing fluid towards the fluid discharging from the fluid discharge orifice.

4. The spray device according to claim 1 wherein the liquid discharge orifice is located downstream of the annular atomizing fluid discharge orifice a distance of at least approximately 1 mm. plus the diameter of the liquid discharge orifice.

5. The spray device according to claim 1 further including a valve needle supported in the body for movement between a retracted open position for permitting liquid discharge through the liquid spray tip and a closed position for preventing liquid discharge through the liquid spray tip.

6. A spray device comprising:
a body having a liquid discharge passage;
a spray nozzle assembly affixed to the body, the spray nozzle assembly including a liquid spray tip for directing liquid from the liquid passage in the body into a predetermined spray pattern and an atomizing fluid cap, the liquid spray tip including a forwardly extending nose portion that defines a liquid discharge orifice, the nose extending through a central opening in the air cap thereby defining an annular atomizing fluid discharge orifice that communicates with an atomizing fluid inlet, the atomizing fluid cap including a pair of opposed angled fan atomizing fluid passages each having a respective fan discharge orifice that is located upstream of the annular atomizing fluid discharge orifice and the liquid discharge orifice.

7. The spray device according to claim 6 wherein the atomizing fluid cap includes an end face having a pair of V-shaped cutouts therein on opposite sides of the atomizing fluid discharge orifice, each fan discharge orifice being arranged in an angled side of a respective one of the V-shaped cutouts so as to direct atomizing fluid towards the fluid discharging from the fluid discharge orifice.

8. The spray device according to claim 6 further including a valve needle supported in the body for movement between a retracted open position for permitting liquid discharge through the liquid spray tip and a closed position for preventing liquid discharge through the liquid spray tip.

9. A spray device comprising:
a body having a liquid discharge passage;
a spray nozzle assembly affixed to the body, the spray nozzle assembly including a liquid spray tip for directing liquid from the liquid passage in the body into a predetermined spray pattern and an atomizing fluid cap, the liquid spray tip including a forwardly extending nose portion that defines a liquid discharge orifice, the nose extending through a central opening in the air cap thereby defining an annular atomizing fluid discharge orifice that communicates with an atomizing fluid inlet, the nose extending in a downstream direction past the central opening in the air cap such that the liquid discharge orifice is arranged a distance of at least approximately 1 mm. plus the diameter of the liquid discharge orifice downstream of the annular atomizing fluid discharge orifice, the atomizing fluid cap including a pair of opposed angled fan atomizing fluid passages each having a respective fan discharge orifice that is located upstream of the annular atomizing fluid discharge orifice and the liquid discharge orifice.

10. The spray device according to claim 9 further including a valve needle supported in the body for movement between a retracted open position for permitting liquid discharge through the liquid spray tip and a closed position for preventing liquid discharge through the liquid spray tip.
